(19) United States
(12) Patent Application Publication
(10) Pub. No.: US 2009/0184649 A1
(43) Pub. Date: Jul. 23, 2009

(54) CURRENT BREAKING CONTROLLER FOR A LAMP AND LANTERN

(76) Inventor: Hsien-Heng LEE, Taichung City (TW)

Correspondence Address: SINORICA, LLC, 2275 Research Blvd., Suite 500, ROCKVILLE, MD, 20850, US

(21) Appl. No.: 12/018,529

(22) Filed: Jan. 23, 2008

(51) Int. Cl. H05B 37/02

(52) U.S. Cl. 315/206

(57) ABSTRACT

An overcurrent breaking controller for a lamp and lantern comprises a trigger control unit connected to an AC power, a current transformer connected between the trigger control unit and the lamp and lantern, and an overcurrent restraint unit connected to the trigger control unit and the current transformer. When the lamp and lantern works with a current exceeding a rated power, the overcurrent restraint unit instantly controls the trigger control unit to stop triggering; after the current drops, the AC power is re-supplied to make the lamp and lantern become bright. Thus, the current of the consumed power of lamp and lantern is restrained and automatically returns for achievement of forced power saving and easy installation.

### BACKGROUND OF THE INVENTION

1. Field of the Invention

This invention relates to a device that forces electricity economy and particularly to a current breaking controller for economizing on energy of a lamp and lantern.

2. Description of Related Art

At the age of energy shortage and green house effect on Earth, in order to economize source of energy and protect environments on Earth, advanced countries' governments has publicly proclaimed to force the use of an energy saving lamp bulb for a lamp and lantern as an illuminator; further in order to economize in electricity, the governments stipulate for the use of each of the lamp and lantern that must be provided with an overcurrent breaking controller sensing a current fed to the lamps and lanterns; USA stipulate for the use of energy saving lamp and lantern starting from year 2009.

With reference to FIG. 1, the overcurrent breaking controller currently used is generally a No-Fuse Breaker (NFB) 1. One terminal of the NFB 1 is coupled to an AC power 2, while the other terminal is coupled to a lamp and lantern 3. A switch 4 is connected in series between the lamp and lantern 3 and the AC power 2. When the switch 4 is ON, the lamp and lantern 3 becomes bright. When the lamp and lantern 3 become bright and a current generated from its power consumption exceeds a rated current, the NFB 1 is excessively heated and mechanically interrupts the supplied power 2 for protection; namely, the rated current of NFB 1 is 1.5 Ampere. When the lamp and lantern 3 becomes bright, the 2 A current is generated that is more than the current of NFB 1 that is rated to 1.5 A. At this time, a trip occurs inside the NFB 1 because being heated, and disconnection of the lamp and lantern 3 from the AC power 2 is made, thereby the circuit of lamp and lantern 3 stays open.

Consequently, because of the technical defects of described above, the applicant keeps on carving unflaggingly through wholehearted experience and research to develop the present invention, which can effectively improve the defects described above.

### SUMMARY OF THE INVENTION

A conventional Non-Fuse Breaker (NFB) 1 is heated and mechanically interrupted due to a current passing through, so the circuit of lamp and lantern 3 stays open but cannot recover, and the NFB 1 must be manually again recovered and is inconveniently used for operation.

In this invention, a current breaking controller for a lamp and lantern is provided, being connected between an AC power and the lamp and lantern. The current breaking controller for the lamp and lantern mainly comprises a trigger control unit made up with a DIAC or a TRIAC, a current transformer, and an overcurrent restraint unit made up with a silicon-controlled rectifier (SCR) and a bridge rectifier. One terminal of the trigger control unit is connected to the AC power, while the other terminal is connected to the current transformer and then the lamp and lantern. The overcurrent restraint unit is connected between the trigger control unit and the current transformer. When the trigger control unit triggers the lamp and lantern to be bright, the lamp and lantern starts to consume power and a load current is generated in the circuit; the current transformer converts the load current into an induced voltage. Thus, when the load current generated due to the power consumption of lamp and lantern is excessive, the induced voltage generated by the current transformer is excessive, too. When the induced voltage exceeds a rated voltage of the overcurrent restraint unit, the overcurrent restraint unit controls and stops the trigger control unit working to make the lamp and lantern go out; when the load current generated due to the power consumption of lamp and lantern drops and stays lower than the rating, the trigger control unit re-starts to make the lamp and lantern become bright again. Thus, the overcurrent breaking controller for the lamp and lantern may not only prevent a user from replacing a damaged lamp bulb of which a rated current or power through ignorance but also automatically turn off the power supply for protection, and no extra power supply does not need to be connected, thereby power saving and easy installation being achieved and even energy waste being prevented.

### BRIEF DESCRIPTION OF THE DRAWINGS

FIG. 1 is a view of a conventional power protection circuit;

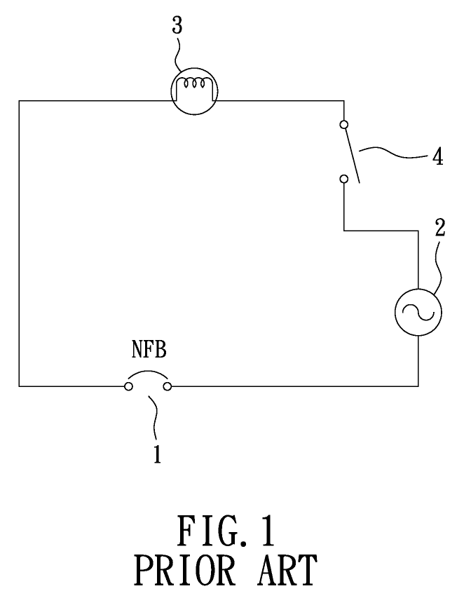

FIG. 2 is a block diagram of a circuit according to this invention; and

FIG. 3 is a view of a preferred embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

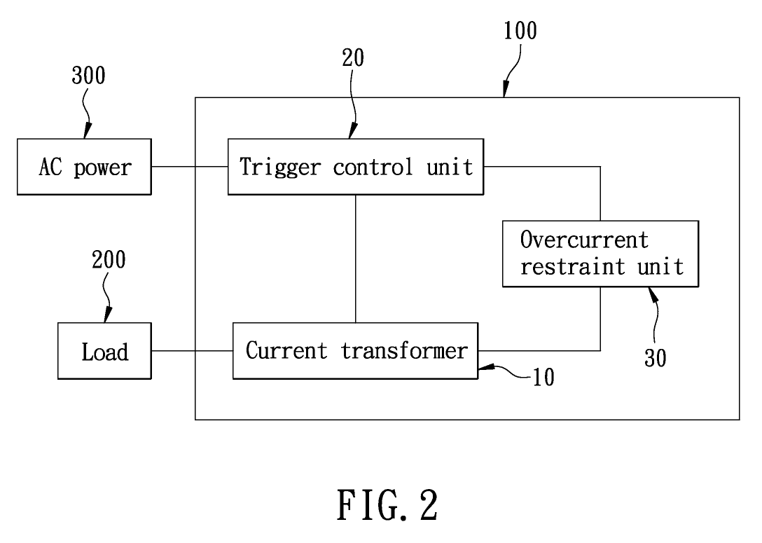

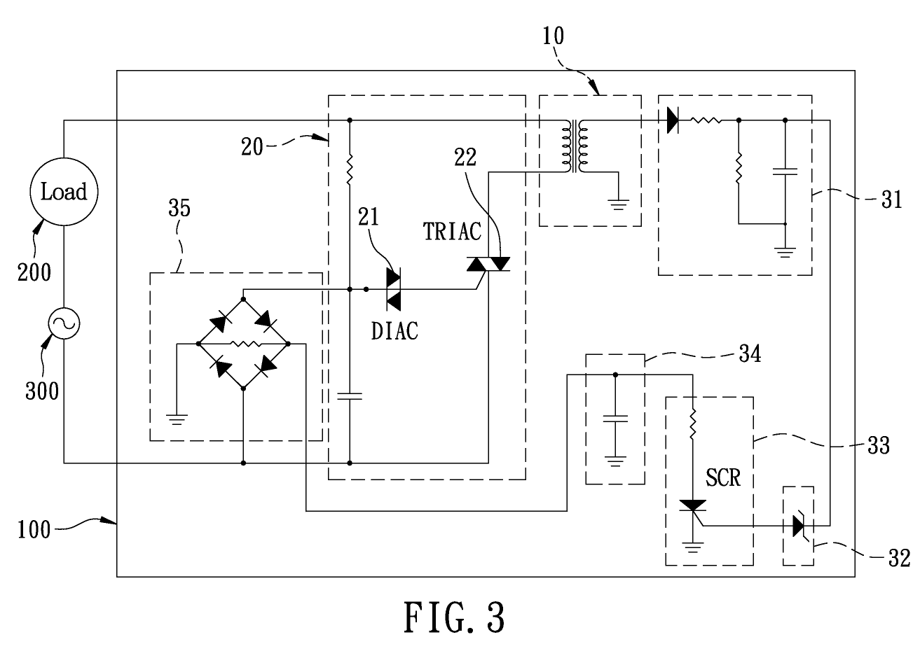

With reference to FIGS. 2 and 3, a preferred embodiment of an overcurrent breaking controller for a lamp and lantern 100 is provided in this invention. One terminal of the overcurrent breaking controller for the lamp and lantern 100 is connected in series to a load 200, while the other terminal is connected to an AC power 300 to control the load 200. The load 200 in the preferred embodiment of this invention is the lamp and lantern of which the overcurrent breaking controller 100 mainly comprises a current transformer 10, a trigger control unit 20, and an overcurrent restraint unit 30.

One terminal of the current transformer 10 is connected to the load 200. The current transformer 10 mainly comprises a primary coil with small number of coils, and a secondary coil with large number of coils. In the preferred embodiment of this invention, a ratio of the primary coil to the secondary coil is set to 1:150. Thus, when a current passing through the load 200 increases, an induced current generated by the primary coil of the current transformer 10 increases and the induced voltage generated by the secondary coil increases, thereby the current transformer 10 being featured with an effect of amplification.

One terminal of the trigger control unit 20 is connected to the AC power 300, and the other terminal is connected to the current transformer 10 to trigger and control the load 200 connected to the other terminal of the current transformer 10. The trigger control unit 20 is further a phase control circuit. In the preferred embodiment of this invention, the phase control circuit is a full wave phase control circuit, mainly comprising a Diode for Alternating Current (DIAC) 21 and a TRIode for Alternating Current (TRIAC) 22, in which the DIAC 21 is connected in series to a Gate of the TRIAC 22. Thus, the DIAC 21 that turns ON may trigger the TRIAC 22 so as to make the DIAC 21 further control the load 200 to become bright.

One terminal of the overcurrent restraint unit 30 is connected to the current transformer 10, while the other terminal is connected to the trigger control unit 20. With reference to again FIG. 3, the unit 30 mainly comprises a half wave rectifier voltage division circuit 31, a voltage regulator circuit 32, a Silicon-Controlled Rectifier (SCR) 33, a delay circuit 34, and a bridge rectifier 35. An anode terminal of the SCR 33 is connected to the bridge rectifier 35 and further to the DIAC 21 provided in the trigger control unit 20. A terminal of the DIAC 21 that is connected to a charging and discharging capacitor is connected to the bridge rectifier 35. The SCR 33 is further connected to the delay circuit 34. In the preferred embodiment of this invention, the anode of SCR 33 is connected in parallel to a capacitor, the other terminal as Gate that is connected to the regulator circuit 32 is further connected to the half wave rectifier voltage division circuit 31 of which the other terminal is connected to the secondary coil of current transformer 10. In the preferred embodiment of this invention, the regulator circuit 32 connects a Zener diode in series to the Gate terminal of SCR 33. When the induced voltage generated in the secondary coil of current transformer 10 is more than the voltage in the regulator circuit 32, the SCR 33 is made to turn ON and further a voltage drop occurs in the charging and discharging capacitor of DIAC 21 connected to the bridge rectifier 35 so as to make the DIAC 21 not turn ON; at this time, the trigger control unit 20 stays at a non-trigger state.

With reference to again FIG. 3, the DIAC 21 that turns ON may trigger the TRIAC 22, the AC power 300 is supplied to the load 200 and the load 200 become bright. At this time, the induced current is generated in the primary coil of current transformer 10 and converted and amplified into an induced voltage in the secondary coil. The induced voltage is a high voltage and, after being rectified and divided by the half wave rectifier voltage division circuit 31, is detected by the regulator circuit 32. When the current that is generated due to the consumed power of the load 200 is higher than the rated current, it exceeds the predetermined current; the induced voltage generated in the secondary coil of current transformer 10 is also higher than the setting value of voltage of the regulator circuit 32 and the Zener diode in the regulator circuit 32 is made to turn ON; besides, the Gate terminal of SCR 33 is triggered so as to make the SCR 33 turn ON and constantly ON because of a time delay of the delay circuit 34. At this time, the bridge rectifier 35 also takes effect so as to make the voltage generated by the charging and discharging capacitor of the DIAC 21 connected to the other terminal of the rectifier 35 drop. When the voltage passing through the DIAC 21 is lower than its trigger voltage, in this invention, the trigger voltage is 30V. Here, the DIAC 21 does not turn ON and not trigger the TRIAC 22, so the TRIAC 22 does not turn ON, thereby the circuit between the load 200 and the AC power 300 stays open. At present, the load current passing through the current transformer 10 drops and the load 200 is not bright, thereby the overcurrent breaking control being achieved. When the current generated from the power consumption of the load 200 is lower than the rated current, the trigger control unit 20 re-trigger the load 200 and the load 200 becomes again bright. Thus, the effect of protection is achieved, a damaged lamp bulb of which a rated current or power exceeds is prevented from being replaced by a user of ignorance for achievement of energy economization. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An overcurrent breaking controller for a lamp and lantern, one terminal of the overcurrent breaking controller for the lamp and lantern being connected in series to a load, and the other terminal being connected to an AC power so as to detect a current generated from a consumed power of the load and control the connected load, the overcurrent breaking controller mainly comprising:
a current transformer of which a terminal is connected to the load, the current transformer mainly comprising a primary coil with small number of coils, and a secondary coil with large number of coils, when the current passing through the load increases, an induced current generated by the primary coil of the current transformer increasing and the induced voltage generated by the secondary coil increasing;
a trigger control unit of which one terminal is connected to the AC power and the other terminal is connected to the current transformer to trigger and control the load connected to the other terminal of the current transformer; and
an overcurrent restraint unit of which one terminal is connected to the current transformer and the other terminal is connected to the trigger control unit, when the load generates the overcurrent, the induced voltage generated in the secondary coil of current transformer being higher than a rated voltage of the overcurrent restraint unit, and the overcurrent restraint unit being enabled to control the trigger control unit to not turn ON.

2. The overcurrent breaking controller for the lamp and lantern according to claim 1, wherein the trigger control unit is a phase control circuit.

3. The overcurrent breaking controller for the lamp and lantern according to claim 2, wherein the phase control circuit is a full wave phase control circuit, mainly comprising at least one Diode for Alternating Current (DIAC) and at least one TRIode for Alternating Current (TRIAC), the DIAC being connected in series to Gate of the TRIAC, thereby an electronic switch being formed.

4. The overcurrent breaking controller for the lamp and lantern according to claim 1, wherein the overcurrent restraint unit mainly comprises a half wave rectifier voltage division circuit, a regulator circuit, a Silicon-Controlled Rectifier (SCR), and a bridge rectifier, in which one terminal of SCR is connected through the bridge rectifier to the trigger control unit and the other terminal is connected through the voltage regulator circuit to the half wave rectifier voltage division circuit, in which the other terminal of half wave rectifier voltage division circuit is connected to the secondary coil of current transformer, and when the induced voltage generated in the current transformer is more than the voltage in the voltage regulator circuit 32, the SCR 33 is made to turn ON and further a voltage drop occurs in the trigger control unit connected to the bridge rectifier to make the trigger control unit not turn ON.

5. The overcurrent breaking controller for the lamp and lantern according to claim 4, wherein the voltage regulator circuit mainly comprises a Zener Diode.

6. The overcurrent breaking controller for the lamp and lantern according to claim 4, wherein the SCR is further connected to a delay circuit.

7. The overcurrent breaking controller for the lamp and lantern according to claim 6, wherein a capacitor is connected in parallel to Anode of the SCR in the delay circuit.

8. The overcurrent breaking controller for the lamp and lantern according to claim 1, wherein the load is a lamp and lantern.
